(19) United States
(12) Patent Application Publication
(10) Pub. No.: US 2004/0025879 A1
(43) Pub. Date: Feb. 12, 2004

(54) Method and apparatus for filtering and adsorbing biological and chemical agents

(76) Inventors: Roger C.Y. Wang, Richmond (CA); John J. Titus, Jefferson, MA (US); Frederick M. Jameson, Sle, UT (US)

Correspondence Address: KIRTON & McCONKIE, 60 East South Temple, Suite 1800, Salt Lake City, UT, 84111, US

(21) Appl. No.: 10/290,862

(22) Filed: Nov. 7, 2002

Related U.S. Application Data
(60) Provisional application No. 60/337,946, filed on Nov. 9, 2001.

(51) Int. Cl. A62B 7/10; A62B 23/02

(52) U.S. Cl. 128/205.29; 128/205.28

(57) ABSTRACT

A method and apparatus for protecting humans against hazardous particulate agents such as biological or chemical agents. A special porous cloth contains activated carbon threads that is used as a quick escape mask to cover the mouth and/or nose of a person to protect the person from inhaling hazardous particulates. This simple cloth mask may be designed for short-term emergency respiratory protection and can be particularly convenient for use by people who are in relatively public, enclosed areas (such as in restaurants, bars, or hotel rooms) and who might need to evacuate those areas in a short period of time. The cloth may also be used in other applications, for example, as a tent liner, as a liner for military uniforms or diving suits, or as a water or air filtration device. In addition to protection from hazardous agents, the cloth may sometimes additionally filter out bad odors.

### RELATED APPLICATION

This application claims priority to U.S. Provisional Patent Application Serial No. 60/337,946, filed Nov. 9, 2001, and titled METHOD OF FILTERING AND ADSORBING BIOLOGICAL AND CHEMICAL AGENTS.

### BACKGROUND

1. Field of the Invention

The present invention relates to the filtration and adsorption of chemical and biological agents. More specifically, the present invention relates to a porous, activated carbon cloth that protects humans from hazardous particulate agents by filtering and absorbing biological and chemical agents (and nuclear particulates).

2. Background

Many biological and chemical agents exist that can be used as weapons to cause death or otherwise incapacitate humans. Some of these agents have been used historically and presently as part of warfare campaigns or for political reasons. Some militants worldwide are even going to great lengths to attempt to weaponize these agents for greater effect. Weaponization can include manipulating the particulate size of a given agent in order to more effectively cause inhalation on its target, or, in the case of biological weapons specifically, genetically altering the biological weapon so that antibiotics or vaccines are less effective against that particular biological strain.

Common biological agents that have been recently considered to be of great concern include pneumonic plague, anthrax, smallpox, botulinum, tularemia, yellow fever, hemorraghic fever, and even measles. All of these listed are bacteria except for smallpox, the latter being a virus. Virus particles are typically smaller than 1/100,000 of an inch (or about 3000 angstrom units—atomic diameters). Conversely, bacteria are larger organisms that may fall within the micrometer range.

Chemical agents of concern can include organo-phosphate compounds such as those known as GA, GB, GD, GF, and VX. Additionally, there is also concern about cyanide gas and mustard gas, among others.

Turning to more specifics about various agents, the pneumonic version of the plague is caused by the same bacteria as that which causes bubonic plague; however, the pneumonic plague is acquired by inhaling infected droplets that typically have been expelled from the lungs of an infected person. Death usually occurs in less than three days in virtually all untreated cases. The plague bacterium is vulnerable to several antibiotics if treatment is started within a few hours of the onset of symptoms, provided the bacterium has not been genetically altered to resist antibiotic treatment.

Anthrax (Bacillus anthracis bacterium) as a human infection results from contact with bacterial spores that may enter through an open sore or break in the skin, through ingestion, or via inhalation into the lungs. Spores can be distributed as a dry powder and can remain dormant in the environment and infectious for many years. Because anthrax spores can remain dormant for many years, anthrax spores are often considered to be a weapon of choice for those wanting to engage in biological warfare. Vaccines exist that are effective to pre-treat those at risk. Once the disease is contracted, treatment consists of administering large doses of antibiotics. Untreated anthrax, particularly inhalation anthrax, is usually fatal. Weaponized anthrax is thought to include spores from about 1 to 5 micrometers in size.

Botulism (Clostridium botulinum bacterium) is able to grow only in an oxygen-free atmosphere, such as in canned or preserved foods that have not been properly processed to destroy the bacteria and its toxin. The toxin is rapidly absorbed into the bloodstream from the intestines. Symptoms appear within a few hours of ingestion and can quickly result in death from respiratory paralysis and suffocation. Generally, no effective treatment exists.

Tularemia (Francisella tularensis bacterium) or rabbit fever exhibits pneumonic plague-like symptoms, but is fatal usually only if diagnosis and/or treatment is delayed for several weeks. This is typically contracted through direct contact with infected animals or indirectly from bites by infected ticks and flies. The tularemia bacterium is vulnerable to antibiotics.

Turning to viruses, these are generally extremely small parasites that are able to reproduce only within the cells of the hosts they infect. Viruses in themselves are not complete living organisms because they depend on their hosts for many of their fundamental life processes. Viruses are the causal agents of many infectious diseases of plants, animals, and humans. These diseases include smallpox, chicken pox, german measles, herpes, hepatitis, AIDS, rabies, polio, influenza, and all forms of the common cold. Generally, antibiotics are not effective against viruses.

A free virus particle, called a virion, consists of a molecule of nucleic acid (either DNA or RNA) surrounded by a coat of many molecules of protein, fat, or carbohydrate. The virion can begin to reproduce itself and carry on its life program when the nucleic acid enters a host cell. Within the cell, the nucleic acid functions as genetic material and directs the manufacture of new copies of itself, which are then released from the cell to initiate new sites of infection.

Virions of different viruses vary greatly in size, shape, and complexity, but those of any given virus are typically uniform. The smallest and simplest are only about 1/100,000 of an inch long (about 3000 angstrom units) and thus are difficult to filter.

The smallpox virus has historically caused an extremely virulent infection primarily passed from person to person in droplets discharged from the nose or mouth. In 1979, the World Health Organization officially declared the world smallpox-free, although a few research laboratories maintain active virus stocks for research purposes. After infection, a 12-day incubation period will usually transpire before symptoms arise. No specific treatment has been developed to treat a person once the disease has been contracted. Indeed, from historical experience, a mortality rate of up to 40% can be expected. At this time, an effective vaccine exists only in limited quantities. Because smallpox is a virus, it is much smaller than bacterial forms of biological weapons.

The smallpox vaccine, developed in 1796, was the first successful immunization against any infectious agent. Vaccines were later developed against several other viral diseases such as polio, influenza, rabies, and hepatitis. A vaccine consists of either killed virus or live virus that has been rendered incapable of causing disease. A vaccine causes the host body to form antibodies which provide protection against subsequent infections. The protection, however, is only against the specific immunizing virus and viruses closely related to it.

Because of the various sizes of chemical and biological agents that can be used as weapons, it would be desirable to provide a material that can be used in emergency situations to filter and/or adsorb many different biological and chemical agents, particularly when the material is used to prevent these agents to enter the lungs during normal breathing. It would also be desirable to provide a material that offers such filtration and adsorption while also maintaining a relatively easy breathing pattern when such a filter is in use.

### SUMMARY OF THE INVENTION

The present invention basically comprises a method and apparatus for protecting humans against hazardous particulate agents (for example, biological agents, chemical agents, or nuclear particulates). The invention includes a special porous cloth that contains activated carbon threads. In a preferred embodiment, the cloth is used as a mask that covers the mouth and/or nose of a person to protect the person from inhaling hazardous particulates. This simple cloth mask may be designed for short-term emergency respiratory protection and can be particularly convenient for use by people who are in relatively public, enclosed areas (such as in restaurants, bars, or hotel rooms) and who might need to evacuate those areas in a short period of time.

In other embodiments of the present invention, the activated carbon cloth may be used as a tent liner, a liner for uniforms (such as military fatigues) or diving suits, or as a water or air filtration device such as in a HVAC. In addition to protection from hazardous agents, the cloth may sometimes additionally filter out bad odors.

### BRIEF DESCRIPTION OF THE DRAWINGS

The foregoing and other features of the present invention will become more fully apparent from the accompanying drawings when considered in conjunction with the following description and claims. Although the drawings depict only one typical embodiment of the invention and are thus not to be deemed as limiting the scope of the invention, the accompanying drawings help explain the invention in added detail.

FIG. 1 is a top plan view of one embodiment of the present invention.

FIG. 2 is top plan view of the embodiment in FIG. 1 wherein the mask is open and ready for placing over the chin and nose of a person's face.

### DETAILED DESCRIPTION OF THE PREFERRED EMBODIMENTS

The following detailed description, in conjunction with the accompanying drawings (hereby expressly incorporated as part of this detailed description), sets forth specific numbers, materials, and configurations in order to provide a thorough understanding of the present invention. The following detailed description, in conjunction with the drawings and appended claims, will enable one skilled in the relevant art to make and use the present invention.

One purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth for explanatory purposes only, that this description is not intended to limit the invention to these particular embodiments. Indeed, it is emphasized that the present invention can be embodied or performed in a variety of ways. The drawings and detailed description are merely representative of particular embodiments of the present invention.

It must be noted that, as used in this specification and the appended claims, the singular forms “a,” “an,” and “the” include plural references unless the content clearly dictates otherwise.

Reference will now be made in detail to several embodiments of the invention. The various embodiments will be described in conjunction with the accompanying drawings wherein like elements are designated by like numeric characters throughout.

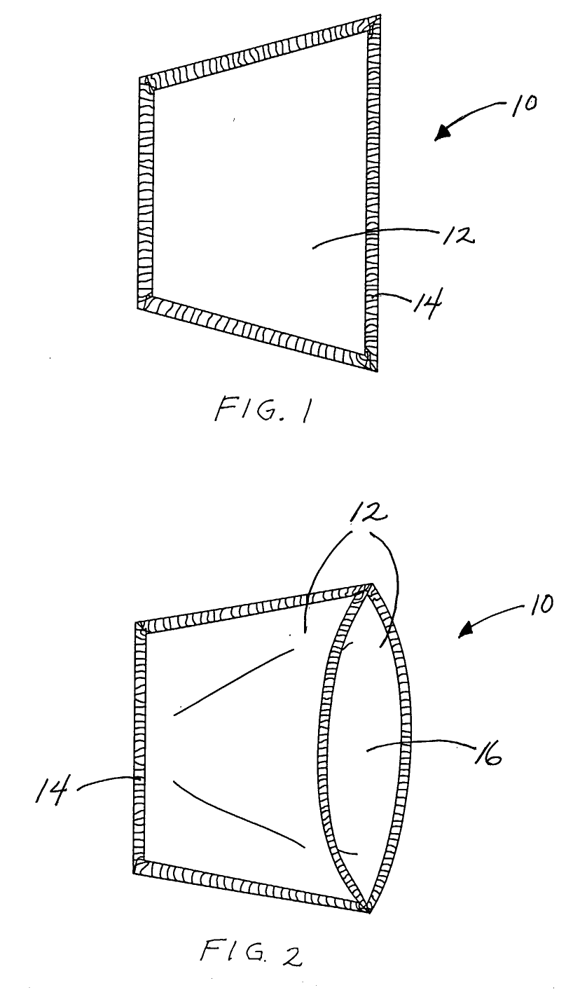

FIG. 1 shows a mask 10 made of activated carbon cloth 12 in accordance with one embodiment of the present invention. “Activated carbon” is the generic term used to describe a family of carbonaceous adsorbents with a highly crystalline form and extensively developed internal pore structure. Activated carbon is similar to crude graphite, such as that used in pencils. For example, activated carbon and graphite are both forms of carbon and contain almost no nitrogen, hydrogen, halogens, sulfur, or oxygen. Some refer to activated carbon as an imperfect form of graphite. However, such an “imperfect” structure provides a high degree of porosity and more than a million-fold range of pore sizes, from visible cracks and crevices to gaps and voids of molecular dimensions. Properties of activated carbon particles can include surface area, pore size distribution, iodine number, carbon tetrachloride activity, hardness, bulk density, particle size distribution, and the like.

The activated carbon cloth 12 includes woven or mat layers of porous cloth that include activated carbon cloth threads. Examples of activated carbon cloths 12 include those manufactured according the process described in U.S. Pat. No. 5,819,350. In the preferred embodiments of the present invention, the cloth 12 comprises a cloth-like cellulose fabric that is made by subjecting the cellulose fabric to an oxygen-poor environment and is oxidized, carbonized, and activated. Such cloth 12, when exposed to high heat, does not burn. Preferably, this cloth 12 is paper-thin and transparent as well.

FIG. 2 shows the embodiment of FIG. 1 wherein the mask 10 is ready for placing over a person's chin and nose for use. As can be seen in FIG. 2, the mask 10 comprises two individual sections and has stitches 14 around the edges. To use this particular embodiment, the user places his or her chin and nose into an opening 16 so that the mask 10 snugly covers the user's mouth and nose. The user holds the mask 10 against his or her face to create and maintain a seal around the face. It will be noted that this embodiment of the mask 10 does not cover the user's eyes; in other words, the seal created by the mask is located below the user's eyes.

The composition and structure, e.g., woven or mat, of the activated carbon cloth 12 is such that biological or chemical agents (and other particulates including nuclear particulates) are either too large to penetrate through the interstices of the fibers, or in the alternative, are adsorbed onto the large surface area of the activated carbon of the cloth. In either event, they are substantially prevented, or at least greatly inhibited, from passing through the fiber layer or layers of the mask 10 into the pulmonary system of the wearer. It will be noted that, in some embodiments of the mask 10, the mask 10 may further include an elastic band (not shown) that is designed to secure the mask 10 to the user's face when the band is secured around the user's head. In addition, in some embodiments, the mask 10 may be used to cover only one inhalation orifice on the user's face—i.e., to cover either the mouth or the nostrils.

The density or weight of the activated carbon cloth 12 can be from about 60 g/m² to 200 g/m², though any functional density of activated carbon cloth can be used. Additionally, in one embodiment, each layer of cloth 12 ranges from 1 mm to 5 mm in thickness, depending on the desired filtration and adsorption ability compared to breathing resistance. If the desire is to slow down the breakthrough or passage of very small biological agents such as viruses, the thickness and density of the activated carbon cloth 12 can be increased, though breathing resistance may also be increased in the process. Alternatively, if multiple cloth layers are used, a thinner layer having a greater density can be used in conjunction with thicker layer having a lower density. Thus, good filtration and adsorption can occur with respect to a reasonable breakthrough time—while simultaneously maintaining low breathing resistance. In one embodiment, providing a deep filter and adsorption bed while maintaining acceptable breathing resistance is desirable. In a preferred embodiment of the mask 10, the mask 10 is primarily designed for quick escape so that an acceptable breakthrough time can be a period of time as small as about 15 minutes; however, shorter time durations could also provide some effectiveness. During this time, the activated carbon cloth 12 preferably provides a low breathing resistance that allows for relatively normal breathing activity.

The activated carbon of the activated carbon cloth 12 can have a relatively high porosity or surface area-to-particle size. In one embodiment, the activated carbon of the cloth 12 can have a pore size from about 900 to 1300 BET. BET refers to a comparative measurement of pore size. This measurement is generally known and can be determined based upon the passing of nitrogen gas through material and quantifying how much actually passes through.

Though any activated carbon cloth 12 can be used with varying degrees of success, i.e., good filtration and adsorption, low breathing resistance, etc., a particular activated carbon cloth 12 for use can include those containing PAN (polyacrylonitrile) -based micro-porous activated carbon. The manufacturing process for this cloth material is described in U.S. Pat. No. 5,819,350. The properties of these activated carbon cloths, in particular, provide the capability to adsorb significantly greater amounts of toxic chemical vapors and biological agents than an equivalent weight of activated carbon granules. The stable structural form of a cloth and the ability to form the fibers into woven patterns or non-woven mats of different densities are also valuable physical features that permit greater consistency in filter construction and performance. For example, less dense but thicker cloth or mat allows greater ease of breathing while maintaining a suitably long adsorption travel path. By matching contaminant concentration and flow-through rate (that is, breathing rate) to cloth activation level (that is, number and frequency of pores and adsorption sites), filter bed depth can be easily adjusted as is desired. This can be achieved well within allowable breathing resistance limits. In this way, adsorption capability can be confidently and closely matched to the expected concentration of the biological or chemical agent.

In one embodiment of the present invention, the cloth 12 is designed to easily fit into a thin, flexible, and lightweight filter mask (not shown) that adapts to the contour of a human face. Preferably, these activated carbon cloths 12 are lightweight and provide low breathing resistance, resulting in comfort and low fatigue even for short-duration applications such as during personal emergency escape.

In another embodiment, though the activated carbon cloth 12 itself is effective for filtering and adsorbing chemical and biological agents, the incorporation of stable oxidizing and/or neutralizing agents into the enhanced micro-pore structure can lead to an even higher level of biological agent filtration/removal effectiveness. In this embodiment, any oxidizing agent and/or neutralizing agent known to be effective against known biological or chemical weapons can be used to counteract a biological or chemical threat.

The mask 10 of the present invention can be useful in various scenarios. For example, the mask 10 may be designed for short-term emergency respiratory protection and can be particularly convenient for use by people who are in relatively public, enclosed areas (such as in restaurants, bars, or hotel rooms) and who might need to evacuate those areas in a short period of time. The mask 10 may also be used in construction environments to protect workers against paint or other chemical fumes; in scientific or forensic laboratories; in stockyards; or in slaughterhouses. It should be emphasized that, in addition to protection from hazardous agents, the cloth 12 may sometimes additionally filter out bad odors. In some embodiments, the cloth 12 can even filters out 100% of any odor present.

In other embodiments of the present invention, the activated carbon cloth may be used as a tent liner, a liner for uniforms (such as military fatigues) or diving suits, or as a water or air filtration device such as in a HVAC. The cloth 12 may be sandwiched in between two layers of an existing material or may be placed against one side or surface of an existing material.

It is underscored that the present invention may be embodied in other specific forms without departing from its spirit or essential characteristics. The described embodiments herein should be deemed only as illustrative. Indeed, the appended claims indicate the scope of the invention; the description, being used for illustrative purposes, does not limit the scope of the invention. All variations that come within the meaning and range of equivalency of the claims are to be embraced within their scope.

What is claimed is:

1. A mask comprising:
a piece of porous cloth for filtering and adsorbing hazardous inhalable particulate agents;
activated carbon threads contained within said cloth; and
a circumference on said cloth, said circumference being shaped to cover and seal off the mouth and nose of a human person when placed against said person's face.

2. The mask of claim 1 wherein the cloth has a density and thickness such that, when the cloth is sealed against said person's face, said person can still breathe well enough to allow the person to quickly escape an area where said hazardous inhalable agents are contained.

3. The mask of claim 1 wherein said circumference seals against the face at points below the person's eyes.

4. The mask of claim 1 wherein the density of the activated carbon in the cloth ranges from about 60 g/m² to 200 g/m².

5. The mask of claim 1 wherein the thickness of the cloth ranges from about 1 mm to 5 mm.

6. The mask of claim 1 wherein the activated carbon has a pore size from about 900 to 1300 BET.

7. The mask of claim 1 further comprising an elastic band coupled to said cloth for securing the cloth to said person's face when said band is secured around the person's head.

8. The mask of claim 1 further comprising an exterior filter mask that adapts to the contour of said person's face, said cloth being fitted inside the exterior mask.

9. The mask of claim 1 wherein said cloth comprises polyacrylonitrile-based micro-porous activated carbon.

10. The mask of claim 1 wherein said cloth further comprises a neutralizing agent for neutralizing said hazardous inhalable agents.

11. The mask of claim 1 wherein said cloth further comprises an oxidizing agent for oxidizing said hazardous inhalable agents.

12. The mask of claim 1 wherein said cloth comprises two individual sections that are coupled on top of each other.

13. A mask comprising:
a lightweight porous cloth for filtering and adsorbing hazardous inhalable particulate agents while simultaneously offering low breathing resistance;
activated carbon threads contained within said cloth; and
a circumference on said cloth, said circumference being shaped to cover and seal off an inhalation orifice of a human person when placed against said person's face, said circumference sealing against the face at points below the person's eyes.

14. The mask of claim 13 wherein the cloth has a density and thickness such that, when the cloth is sealed against said person's face, said person can still breathe well enough to allow the person to quickly escape an area where said hazardous inhalable agents are contained.

15. The mask of claim 13 wherein said cloth has a density, thickness, and composition that prevents inhalation anthrax-causing anthrax spores from passing through said cloth.

16. The mask of claim 13 wherein said cloth has a density, thickness, and composition that prevents smallpox virus-containing droplets from passing through said cloth.

17. The mask of claim 13 wherein said cloth filters out 100 percent of any odors in the atmosphere.

18. The mask of claim 13 wherein said cloth comprises two individual sections that are coupled on top of each other.

19. A quick-escape mask comprising:
a first and second trapezoidal piece of lightweight porous cloth having activated carbon threads, a density, and thickness all to a degree that allows the cloth to filter and adsorb hazardous biological and chemical inhalable agents while simultaneously offering low breathing resistance during a short-term emergency, said first and second pieces of cloth being cut into substantially the same shape, said first and second pieces of cloth each having four edges, said cloth comprising a cellulose that is subjected to an oxygen-poor environment and is oxidized, carbonized, and activated;
stitching on said edges of the first and second pieces of cloth, said stitching causing three of said edges of the first and second pieces of cloth to be coupled together; and
a circumference comprising the non-coupled fourth edges of said first and second pieces of cloth, said circumference being shaped to cover and seal off the mouth and nose of a human person when placed against said person's face, said circumference sealing against the face under the chin and below the eyes of the face.

20. A method comprising:
obtaining an oxidized, carbonized, and activated fiber cellulose cloth;
cutting said cloth into a size that is large enough to cover the nose and mouth of a human person; and
creating a circumference on said cloth that is shaped to seal off said mouth and nose from the atmosphere when the cloth is placed against the person's face.

21. The method of claim 20 wherein said cloth is manufactured to have a density, thickness, and composition that prevents inhalation anthrax-causing anthrax spores from passing through said cloth.

22. The method of claim 20 wherein said cloth is manufactured to have a density, thickness, and composition that prevents smallpox virus-containing droplets from passing through said cloth.

23. The method of claim 20 wherein said cloth is manufactured to have a density, thickness, and composition that prevents pneumonic plague-containing droplets from passing through said cloth.

24. The method of claim 20 wherein said circumference is designed to seal against the face at points below the person's eyes.

25. The method of claim 20 wherein the density of the activated carbon in the cloth ranges from about 60 g/m² to 200 g/m².

26. The method of claim 20 wherein the thickness of the cloth ranges from about 1 mm to 5 mm.

27. The method of claim 20 wherein the activated carbon has a pore size from about 900 to 1300 BET.

28. The method of claim 20 further comprising coupling an elastic band to said cloth for securing the cloth to said person's face when said band is secured around the person's head.

29. The method of claim 20 further comprising placing polyacrylonitrile-based micro-porous activated carbon in said cloth.

30. The method of claim 20 further comprising placing a neutralizing agent in said cloth for neutralizing said hazardous inhalable agents.

31. A method comprising:
providing cellulose material;
subjecting said cellulose material to an oxygen-poor environment;
oxidizing, carbonizing, and activating said cellulose material so that said material becomes an adsorbent fiber cloth having activated carbon threads, said cloth being suitable for filtering and adsorbing hazardous inhalable particulate agents;
cutting said cloth into a size that is large enough to cover the nose and mouth of a human person; and
creating a circumference on said cloth that is shaped to seal off said mouth and nose from the atmosphere when the cloth is placed against the person's face.

32. A method comprising taking an oxidized, carbonized, and activated fiber cellulose cloth and incorporating said cloth into a tent by lining said tent with said cloth.

33. A method comprising taking an oxidized, carbonized, and activated fiber cellulose cloth and incorporating said cloth into clothing by lining said clothing with said cloth.

34. The method of claim 33 wherein said clothing comprises military fatigues.

35. The method of claim 33 wherein said clothing comprises a diving suit.

36. A method comprising taking an oxidized, carbonized, and activated fiber cellulose cloth and incorporating said cloth into an air filtration device.

37. A method comprising taking an oxidized, carbonized, and activated fiber cellulose cloth and incorporating said cloth into a water filtration device.

38. A method comprising taking an oxidized, carbonized, and activated fiber cellulose cloth and incorporating said cloth into a HVAC.
